(19) United States
(12) Patent Application Publication
(10) Pub. No.: US 2009/0225096 A1
(43) Pub. Date: Sep. 10, 2009

(54) LCD DISPLAY AND ELECTRONIC DEVICE

(75) Inventors: Masahiro Yoshiga, Nishiku (JP); Naoki Sumi, Nishiku (JP); Keitaro Yamashita, Nishiku (JP)

Correspondence Address: LOWE HAUPTMAN HAM & BERNER, LLP, 1700 DIAGONAL ROAD, SUITE 300, ALEXANDRIA, VA, 22314, US

(73) Assignee: TPO Displays Corp., Kobe-shi (JP)

(21) Appl. No.: 12/398,910

(22) Filed: Mar. 5, 2009

(30) Foreign Application Priority Data
Mar. 5, 2008 (JP) 2008-054253

(51) Int. Cl. G09G 5/36; G09G 3/36

(52) U.S. Cl. 345/545; 345/87

(57) ABSTRACT

Disclosed is an LCD display utilizing a frame memory and a lookup table for pixel overdrive. A plurality of pixels is arranged in an array corresponding to the gate lines and the source lines. The frame memory is a memory formed by at least one storage capacitor and at least one thin film transistor in each pixel. Moreover, a compression unit and a decompression unit are coupled with the frame memory. The compression unit outputs compressed gradation data of the present image. The decompression unit outputs decompressed gradation data of the former image.

### CROSS REFERENCE TO RELATED APPLICATIONS

This Application claims priority of Japanese Patent Application No. 2008-054253, filed on Mar. 5, 2008, the entirety of which is incorporated by reference herein.

### BACKGROUND OF THE INVENTION

1. Field of the Invention

The present invention generally relates to a liquid crystal display (LCD display), and more particularly to a frame memory of pixel overdrive in a liquid crystal display (LCD display).

2. Description of Prior Art

Recently, LCD displays are utilized not only for manufacturing computer monitors or LCD TV, but also for manufacturing other products, such as cellular phones, digital cameras, Personal Digital Assistants (PDAs), and various portable electronic devices. However, because the LCD display response time cannot be sufficiently short, display of residual image remains a problem. Therefore, a pixel overdrive can be utilized to drive the LCD display so that the LCD display can have a shorter response time. In showing fast motion images thereupon by the pixel overdrive, a higher voltage is provided to the liquid crystals than would be generally provided from the gradation data of the former image to the gradation data of the present image when the changing direction is positive. Conversely, a lower voltage is provided to the liquid crystals than would be generally provided from the gradation data of the former image to the gradation data of the present image when the changing direction is negative. Accordingly, the response time of the LCD display is shortened and the quality of the motion images is improved.

Refer to FIG. 3, which depicts a diagram of a pixel overdrive arrangement. The abscissa expresses the frame time (frame number) when moving from dark gradation to bright gradation, and the ordinate expresses the gradation levels of the LCD display. For example, in a 60 Hz driving circuit of an LCD display, one frame represents 1/60^{th} of a second, i.e. a period of 16.7 milliseconds. For reaching the gradation of the target 1, the signal voltage of the target 1 has to be applied constantly for 5 frames. With the pixel overdrive, the gradation of the target 1 can be reached in 1 frame by applying the signal voltage of OD1 (OVERDRIVE 1). Thereafter, the signal voltage is dropped to the signal voltage of the target 1, and the response time of the LCD display is shortened. Similarly, for reaching the gradation of the target 2, the signal voltage of the target 2 has to be applied constantly for 4 frames. With the pixel overdrive, the gradation of the target 2 can be reached in 1 frame by applying the signal voltage of OD2 (OVERDRIVE 2).

Refer to FIG. 4, which depicts a block diagram of a pixel overdrive circuit according to a prior art. A general pixel overdrive circuit is required to have an independent frame memory 42 to store the look up table 43 and the target gradation data for outputting the proper gradation data to the LCD module (pixel) 41.

However, in the above-mentioned prior art, the independent frame memory 42 cannot be eliminated in such pixel overdrive circuit, a higher production cost will be a concern.

### SUMMARY OF THE INVENTION

An objective of the present invention is to provide a lower production cost LCD display for pixel overdrive without an independent frame memory.

For accomplishing the aforesaid objective of the present invention, a frame memory formed as a memory for pixel overdrive in each pixel is utilized to eliminate an independent frame memory, therefore, a lower production cost LCD display for a pixel overdrive can be provided.

(1) The LCD display of the present invention utilizes a frame memory and a lookup table for pixel overdrive. The LCD display comprises a plurality of pixels arranged in an array corresponding to the gate lines and the source lines. The frame memory is a memory formed by at least one storage capacitor and at least one thin film transistor in each pixel. A compression unit and a decompression unit are coupled with the frame memory, wherein the compression unit outputs compressed gradation data of the present image and the decompression unit outputs decompressed gradation data of the former image.

(2) The LCD display as described in (1), one end of the at least one storage capacitor is coupled to a drain of the thin film transistor, the other end thereof is coupled to one of the gate lines, a source of the at least one thin film transistor is coupled to one of the source lines, and a gate thereof is coupled to a read/write line.

(3) The LCD display as described in (1) or (2), the at least one storage capacitor and the at least one thin film transistor are formed with the same lithography process of a thin film transistor for driving each of the pixels.

(4) The LCD display as described in (1)˜(3), a compression ratio of the compressed data is between 1/4 -1/10.

(5) An electronic device comprises the LCD display as described in (1)˜(4). The electronic device is a cellular phone, a digital camera, a Personal Digital Assistant, a media display in car, a digital frame or a portable DVD player.

### BRIEF DESCRIPTION OF THE DRAWINGS

FIG. 1 depicts an embodiment of a frame memory according to the present invention;

FIG. 2 depicts a diagram of a pixel overdrive circuit according to the present invention;

FIG. 3 depicts a diagram of a pixel overdrive arrangement;

FIG. 4 depicts a block diagram of a pixel overdrive circuit according to a prior art.

### DETAILED DESCRIPTION OF THE INVENTION

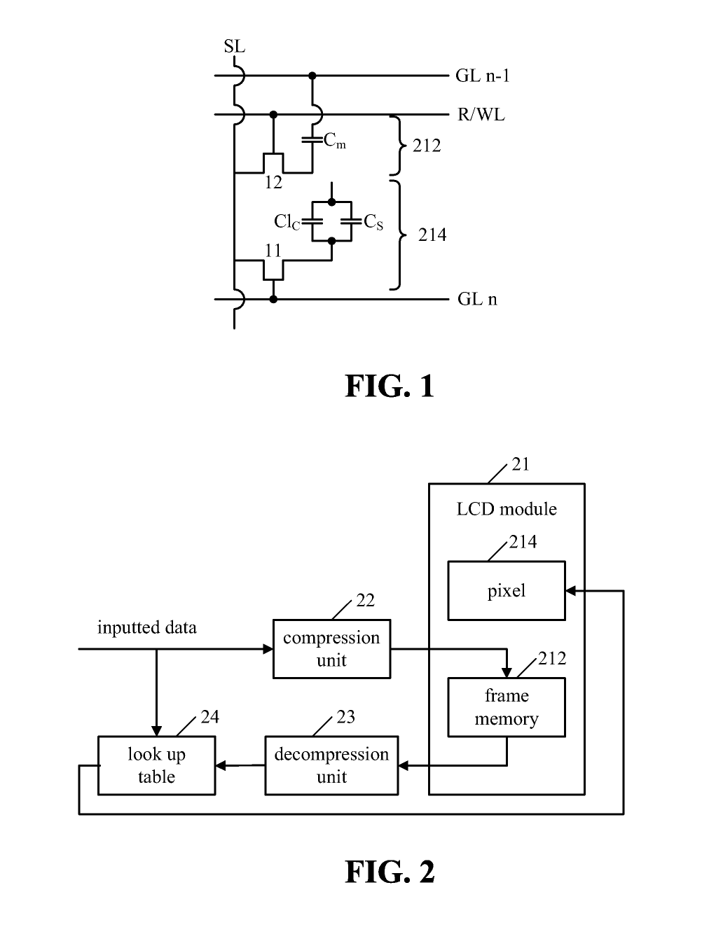

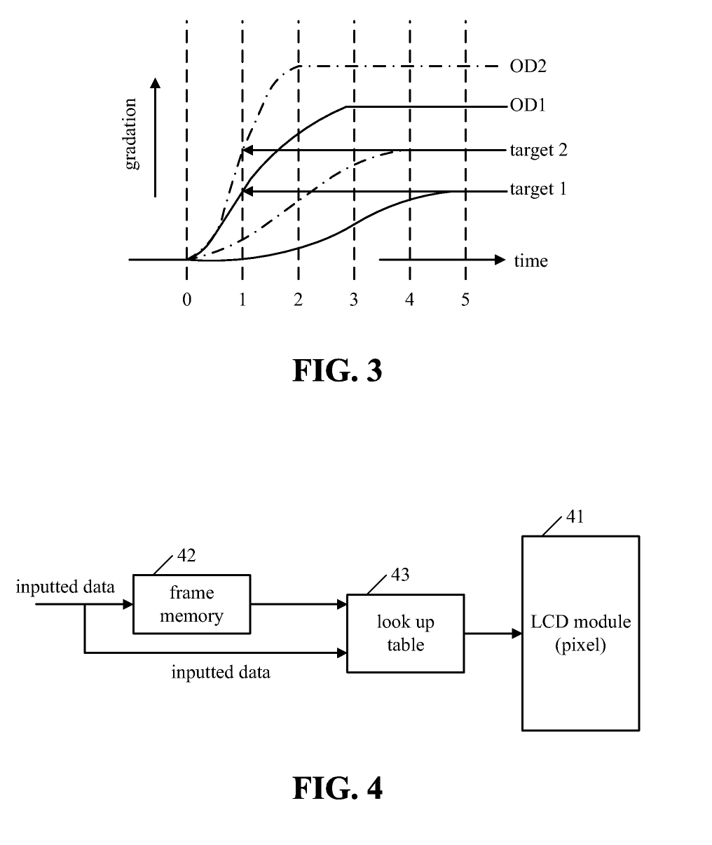

Refer to FIG. 1, which depicts an embodiment of a frame memory according to an embodiment of the present invention. As shown in FIG. 1, each pixel is surrounded by gate lines GLn-1, GLn, and source lines SL. Besides, each pixel comprises a frame memory 212 which is coupled with a read/write line R/WL. Generally, the pixel unit 214 comprises a thin film transistor 11, a storage capacitor Cs and a liquid crystal Clc. The storage capacitor Cs and the liquid crystal Clc are coupled to the thin film transistor 11. Inside each pixel area, the frame memory 212 comprises a storage capacitor Cm and a thin film transistor 12. The storage capacitor Cm stores gradation data of an image. The thin film transistor 12 is utilized to select read/write line R/WL. One end of the storage capacitor Cm is coupled to the drain of the thin film transistor 12, and the other end is coupled to the gate line GLn-1. The source of the thin film transistor 12 is coupled to the source line SL, and the gate of the thin film transistor 12 is coupled to the read/write line R/WL.

Refer to FIG. 2, which depicts a diagram of a pixel overdrive circuit according to an embodiment of the present invention. As shown in FIG. 2, the frame memory 212 is formed therewithin a pixel of an LCD module 21. A compression unit 22 and a decompression unit 23 are coupled with the frame memory 212. The compression unit 22 outputs compressed gradation data of the present image. The decompression unit 23 outputs decompressed gradation data of the former image.

As shown in FIG. 2, the gradation data of the present image is compressed as inputted data by the compression unit 22 and inputted into the frame memory 212. At present, the read/write line R/WL is selected and the foregoing compressed inputted data is written into the storage capacitor Cm. Initially, the read/write line R/WL is selected during the execution of the pixel overdrive. The gradation data of the former image which is stored in the frame memory 212 is read and the decompression unit 23 decompresses the gradation data of the former image. The decompressed gradation data of the former image is then inputted into the look up table 24 for comparison process with the gradation data of the present image. With the aforesaid comparison, the overdrive voltage is determined and inputted into the pixel 214. If the gradation data of the former image and the gradation data of the present image are the same, the pixel overdrive will not be processed. If the gradation data of the former image and the gradation data of the present image are different, then the pixel overdrive will be processed. Furthermore, as the read line is closed, the gate line is selected and the overdrive voltage is applied to the pixel. Finally, as the gate line is closed, the write line is opened and the gradation data of the present image is stored in the frame memory 212.

The frame memory of the present invention can be utilized not only in the foregoing structure, but also SRAM or other types of memories to realize the same achievement. Moreover, the same objective can be realized by utilizing at least two thin film transistors and at least two storage capacitors in combination.

A compression ratio of the compression unit of the present invention can be between 1/4-1/10and there is no particular restriction to the decompression unit.

Because the frame memory comprises the storage capacitor and the thin film transistor, the frame memory can be formed with the same lithography process of a thin film transistor for driving the pixel. Accordingly, the manufacture cost is lower than the prior arts utilizing an independent frame memory.

The look up table of the LCD display stores gradation data for pixel overdrive according to the present invention. The gradation data for pixel overdrive is obtained by experiment in advance. Alternatively, two look up tables can also be illustrated. One is for determining the overdrive voltage and the other is for determining predictive voltage.

The LCD display can also be applied in an electronic device, such as a cellular phone, a digital camera, a Personal Digital Assistant, a media display in car, a digital frame and a portable DVD player.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An LCD display, comprising:
a plurality of pixels, arranging in an array corresponding to gate lines and source lines;
a frame memory, forming by at least one storage capacitor and at least one thin film transistor in each pixel; and
a compression unit and a decompression unit, coupling with the frame memory, wherein the compression unit outputs compressed gradation data of a present image and the decompression unit outputs decompressed gradation data of a former image.

2. The LCD display according to claim 1, wherein one end of the at least one storage capacitor is coupled to a drain of the thin film transistor, the other end thereof is coupled to one of the gate lines, a source of the at least one thin film transistor is coupled to one of the source lines, and a gate thereof is coupled to a read/write line.

3. The LCD display according to claim 1, wherein the at least one storage capacitor and the at least one thin film transistor are formed with the same lithography process of a thin film transistor for driving each of the pixels.

4. The LCD display according to claim 1, wherein a compression ratio of the compressed data is between 1/4-1/10.

5. An electronic device, comprising the LCD display of claim 1, wherein the electronic device is a cellular phone, a digital camera, a Personal Digital Assistant, a media display in car, a digital frame and a portable DVD player.
